(19) United States
(12) Patent Application Publication
(10) Pub. No.: US 2014/0157169 A1
(43) Pub. Date: Jun. 5, 2014

(54) CLIP BOARD SYSTEM WITH VISUAL AFFORDANCE

(71) Applicant: MICROSOFT CORPORATION, Redmond, WA (US)

(72) Inventor: Erez Kikin-gil, Redmond, WA (US)

(73) Assignee: Microsoft Corporation, Redmond, WA (US)

(21) Appl. No.: 13/705,170

(22) Filed: Dec. 5, 2012

(51) Int. Cl. G06F 3/0486

(52) U.S. Cl. CPC G06F 3/0486
USPC 715/770

(57) ABSTRACT

A clip board system provides a visual affordance for clipped information that is stored on a clip board. A direct manipulation method is used to place items on, and retrieve items from, the clip board. The clip board can also be implemented on a network so that content that is saved on the clip board can easily be accessed by a user using a plurality of different applications or devices.

### BACKGROUND

Computer systems are currently in wide use. Many computer systems implement a clip board that allows a user to perform clip board operations on content. However, current clip board systems implement operations in a way that is quite abstract and indirect. Thus, the systems are fairly cumbersome and unintuitive.

For example, some clip board systems enable a user to perform cut/copy/paste operations on content. In performing such operations, a user first selects content in one of a variety of different ways. The content can be highlighted using a point and click device or using a set of key strokes, for instance. The user then actuates a user input mechanism on a user interface display to indicate that the user wishes to either cut or copy the content. In response, the selected content is saved in a clip board that is normally invisible to the user.

The selection, cutting and copying operations are usually done either through keyboard shortcuts or by clicking on context menus using a point and click device. The operations are thus indirect, and limit the user's ability to build a correct mental model of the data that has been selected and saved to the clip board. Further, these operations require the user to engage in a cognitive effort whereby the user is to remember what content they selected and copied or cut. As a result, the clip board operations are normally only used for short term content manipulation operations.

Current clip board operations present other difficulties as well. For instance, current clip board operations are specific to (or siloed to) a specific device that the user is using at the time the content is selected. Therefore, current clip board operations do not allow the user to easily share strings, files, or other content, between devices using the clip board. Instead, in order for a user to do this, the user normally needs to save the content to a specific location from one device and access it from another device. This operation can also be quite cumbersome and unintuitive.

The discussion above is merely provided for general background information and is not intended to be used as an aid in determining the scope of the claimed subject matter.

### SUMMARY

A clip board system provides a visual affordance for clipped information that is stored on a clip board. A direct manipulation method is used to place items on, and retrieve items from, the clip board. The clip board can also be implemented on a network so that content that is saved on the clip board can easily be accessed by a user using a plurality of different applications or devices.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one embodiment of a computing system.

FIG. 2 is a flow diagram illustrating one embodiment of the operation of the system shown in FIG. 1.

FIGS. 2A-2G show various embodiments of user interface displays.

FIG. 3 is a block diagram showing one embodiment of an architecture containing a clip board service component.

FIG. 4 is a flow diagram illustrating one embodiment of the operation of the system shown in FIG. 3.

FIG. 5 shows one embodiment of the computing system of FIG. 1 in a variety of different architectures.

FIGS. 6-8 show embodiments of mobile devices.

FIG. 9 is a block diagram of one illustrative computing environment.

### DETAILED DESCRIPTION

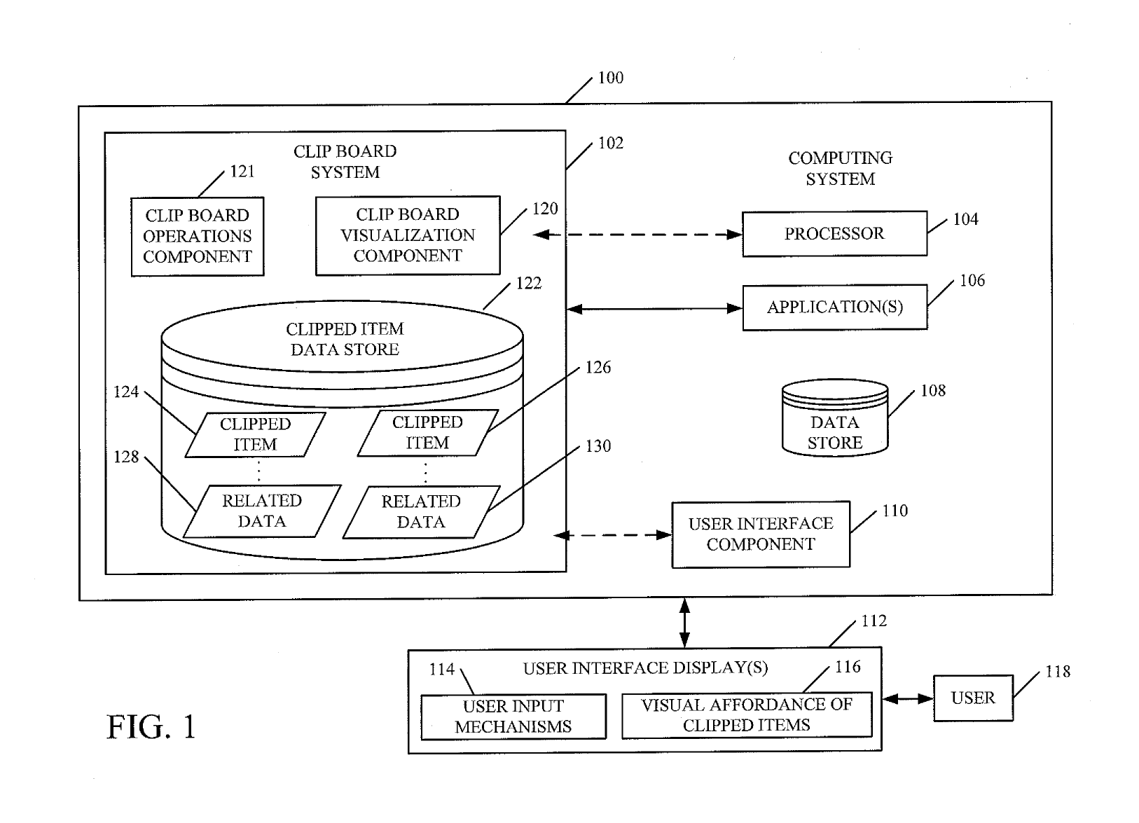

FIG. 1 is a block diagram illustrating one embodiment of computing system 100. Computing system 100 includes clip board system 102, processor 104, applications 106, data store 108 and user interface component 110. FIG. 1 shows computing system 100 generating user interface displays 112 that include user input mechanisms 114 and visual affordance of clipped items 116. Displays 112 are displayed for interaction by user 118.

Clip board system 102, itself, includes clip board visualization component 120, clip board operations component 121, and clipped item data store 122. Data store 122 is shown with a plurality of clipped items 124-126, each having corresponding or related data 128-130.

Processor 104 is illustratively a computer processor with associated memory and timing circuitry (not separately shown). Processor 104 is illustratively a functional component of system 100 and is activated by, and facilitates the functionality of, clip board system 102, applications 106, user interface component 110 and other items in computing system 100.

Applications 106 can include a wide variety of different applications. In one embodiment, one or more of applications 106 are applications for processing content that can be selected and on which clip board operations can be performed. In one embodiment, clip board operations include cut, copy and paste operations. A plurality of the applications 106 are shown coupled to clip board system 102. Thus, clip board system 102 (as is described in greater detail below) can be used across a plurality of different applications 106 and even across a plurality of different devices.

Data store 108 is shown as a single data store and illustratively stores data and code used in computing system 100. While data store 108 is shown as a single data store, that is local to system 100, it can also be multiple different data stores and those data stores can be located remotely from system 100 or some can be located remotely and others can be located locally with respect to system 100.

User interface component 100 illustratively generates user interface displays 112 with user input mechanisms 114. User input mechanisms 114 allow user 118 to provide inputs to manipulate and control computing system 100, and clip board system 102. User input mechanisms 114 can take a wide variety of different forms, such as buttons, drop down menus, text boxes, links, icons, or other user actuable input mechanisms.

The user 118 can actuate user input mechanisms 114 in a variety of different ways as well. For instance, the user 118 can use a point and click device (such as a mouse or track ball), keystrokes on a keyboard (either a virtual keyboard or keypad or a hardware keyboard or keypad), etc. In addition, in one embodiment, where computing system 100 includes a speech recognition component, the user can provide user inputs using a microphone and voice commands to actuate the user input mechanisms 114. Similarly, where the display screen used to display user interfaces 112 is a touch sensitive display, the user can provide user inputs by actuating user input mechanisms 114 using touch gestures with the user's finger, a stylus, etc. Other user input mechanisms 114 or ways of actuating the user input mechanisms 114 can be used as well, and those described above are described for the sake of example only.

Clip board system 102 includes clip board operations component 121 that illustratively implements clip board operations. Clip board visualization component 120 generates clip board visualizations of content clipped from applications 106 when user 118 performs clip board operations on that content. For instance, clip board operations component 121 illustratively allows user 118 to perform clip board operations (such as cut/copy/paste operations) on content being manipulated by one of applications 106. Clip board visualization component 120 illustratively generates visualizations of items selected and placed on a clip board or retrieved from the clip board. Clipped item data store 122 illustratively stores the clipped items 124-126 that are placed on the clip board, along with related data 128-130.

Before describing the operation of system 100 in more detail, a brief overview will be provided for the sake of enhanced understanding. In one embodiment, user 118 first launches one of applications 106, and the launched application uses user interface component 110 to display data on a content canvas of user interface displays 112. User 118 provides inputs using user input mechanisms 114 to select some of the displayed content for being cut or copied and being placed on the clip board (e.g., stored in clipped item data store 122). The launched application 106 accesses clip board system 102 (and specifically clip board operations component 121) to perform the cut or copying operation on the selected content. The user 118 then moves the cut or copied content onto the clip board by using a direct manipulation method. The direct manipulation method provides a visual representation that allows the user to visually move the selected content onto a clip board. In one embodiment, clip board operations component 121 generates user input mechanisms 114 that allow user 118 to drag and drop the selected content onto the clip board. Clip board visualization component 120 then generates a visual affordance representing the content that was just placed onto the clip board. In one embodiment, the visual affordance is a thumbnail or a portion of a thumbnail image of the clipped content. This is in contrast to some current systems where the content placed on the clip board is not visualized on the user interface display. Instead, the user must remember the content placed on the clip board or otherwise actuate some other type of input mechanism in order to see it. Clip board operations component 121 then also generates user input mechanisms 114 that allow user 118 to retrieve the clipped item (such as by dragging and dropping the visual affordance of the clipped item) back onto the content canvas using a paste operation.

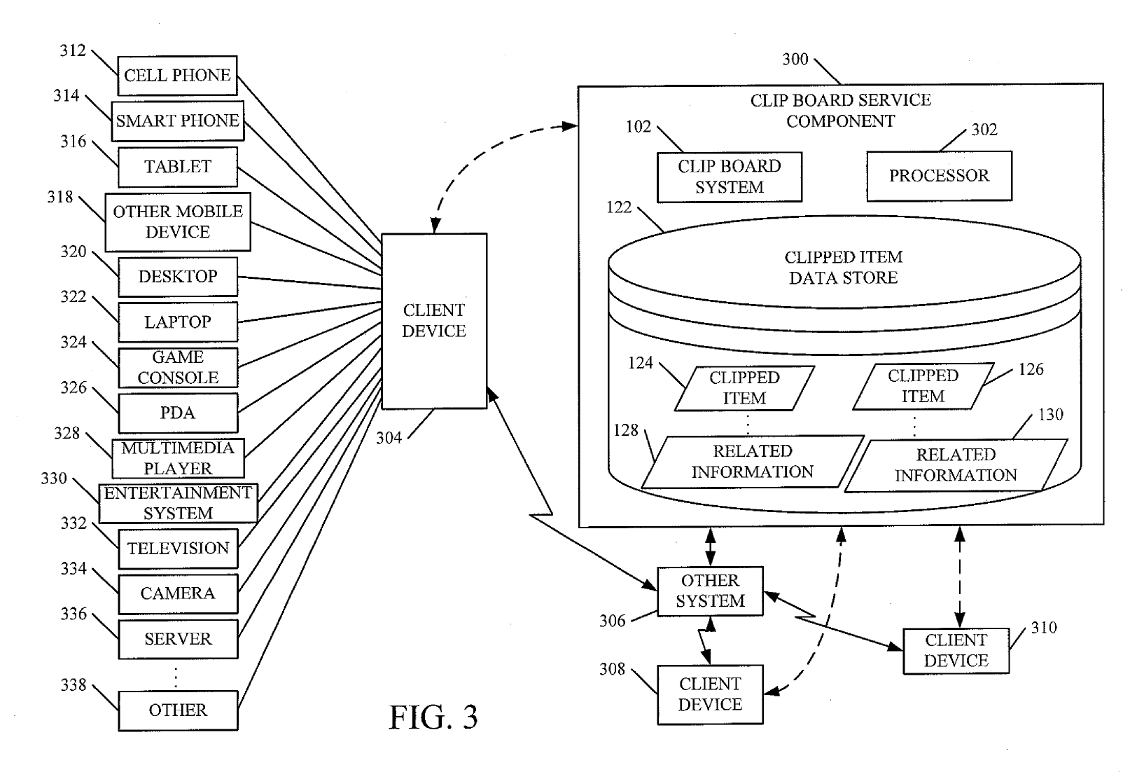

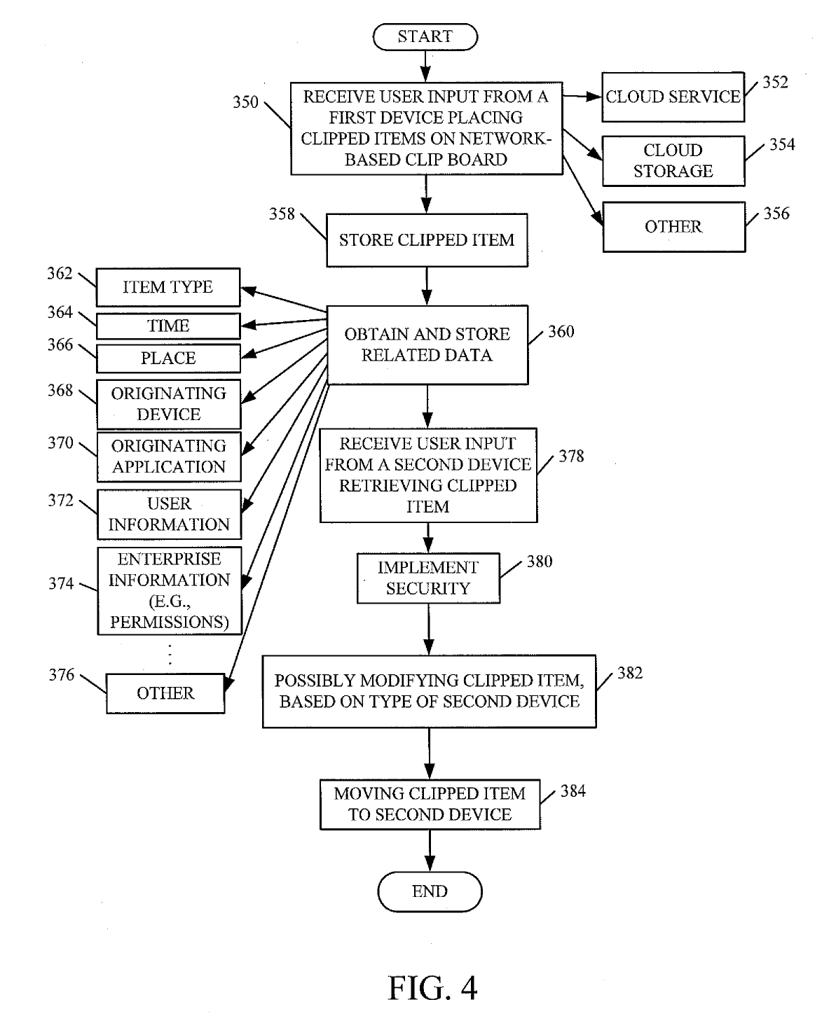

It can thus be seen that clip board system 102 can be a service component that is used across multiple different applications 106. Therefore, if user 118 clips some content from a first application and places it on the clip board, and then launches a second application, the user can simply retrieve the clipped item from the clip board, because it is available across both applications, and is independent of them in that the visual affordance of the clipped items is generated regardless of which application is launched. Thus, the user can see items clipped and placed on the clip board from a variety of different applications, even though the user is using another application which is different from the application from which the content was clipped. The clipped item is also available across different user devices, and this is described in greater detail below with respect to FIGS. 3 and 4.

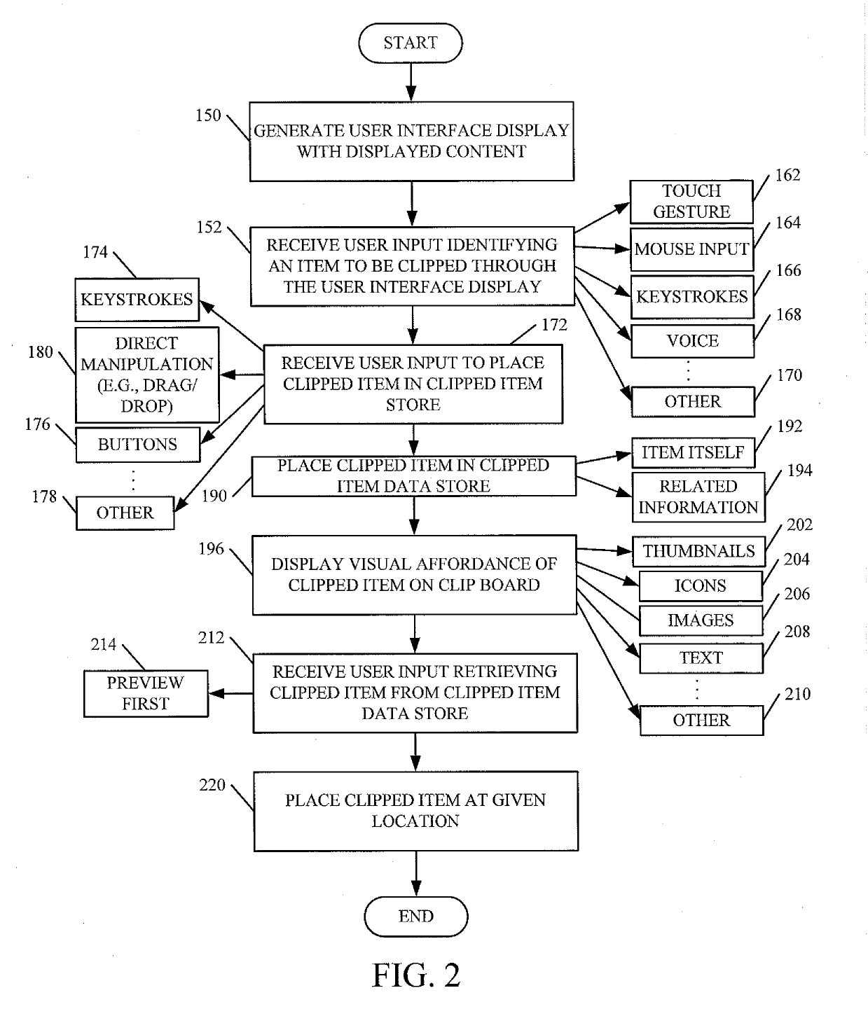

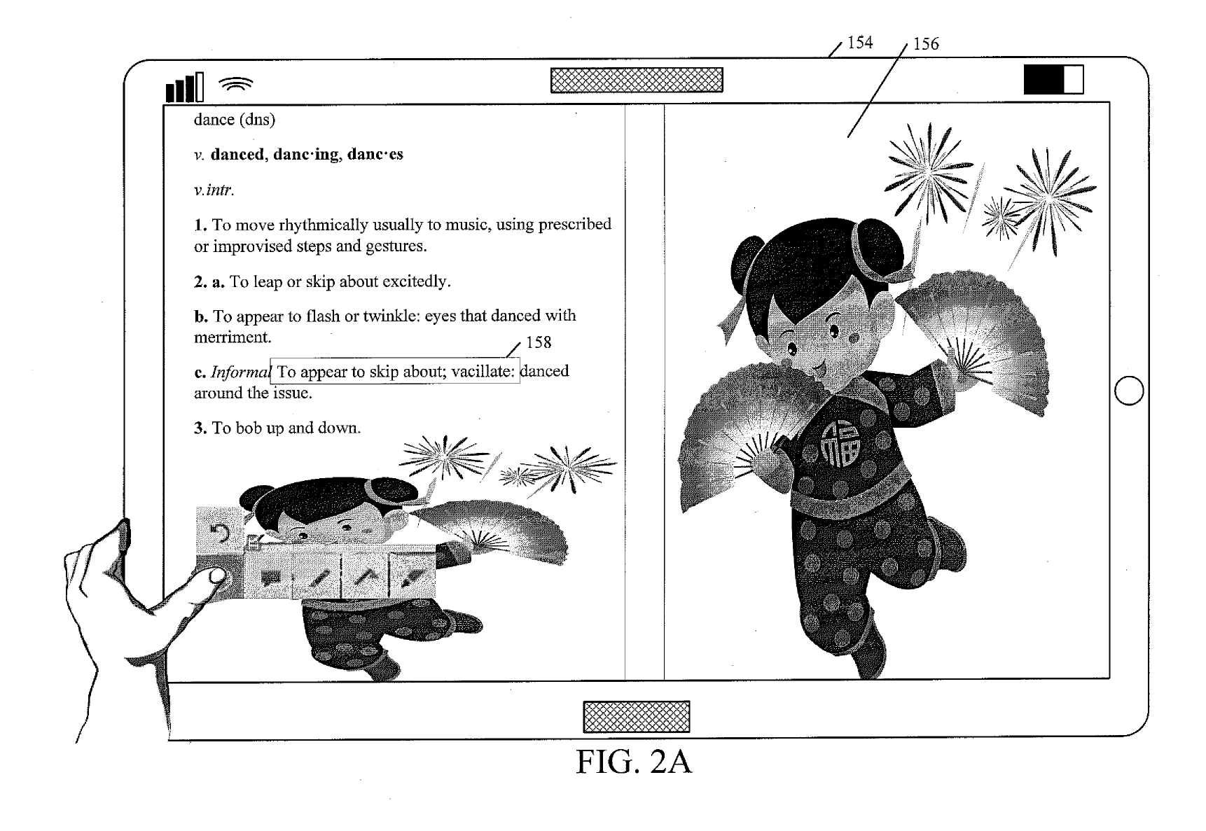

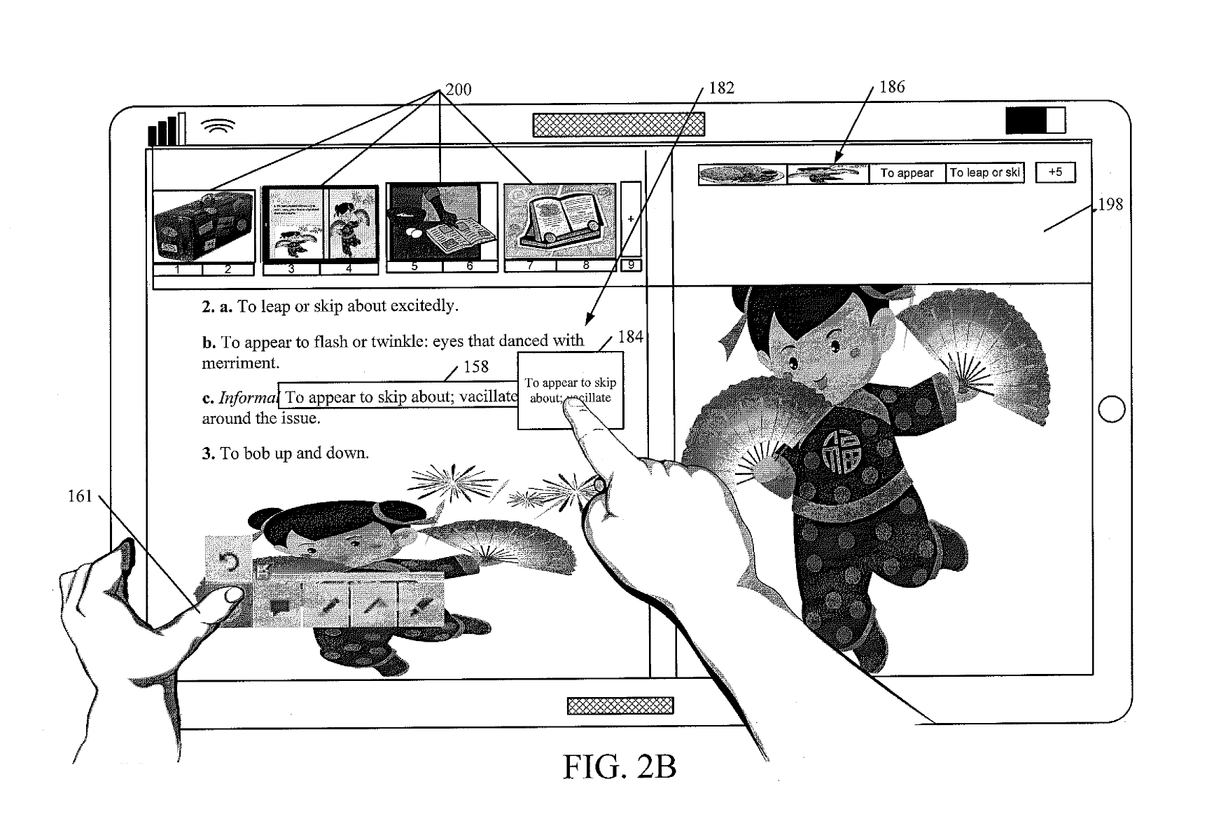

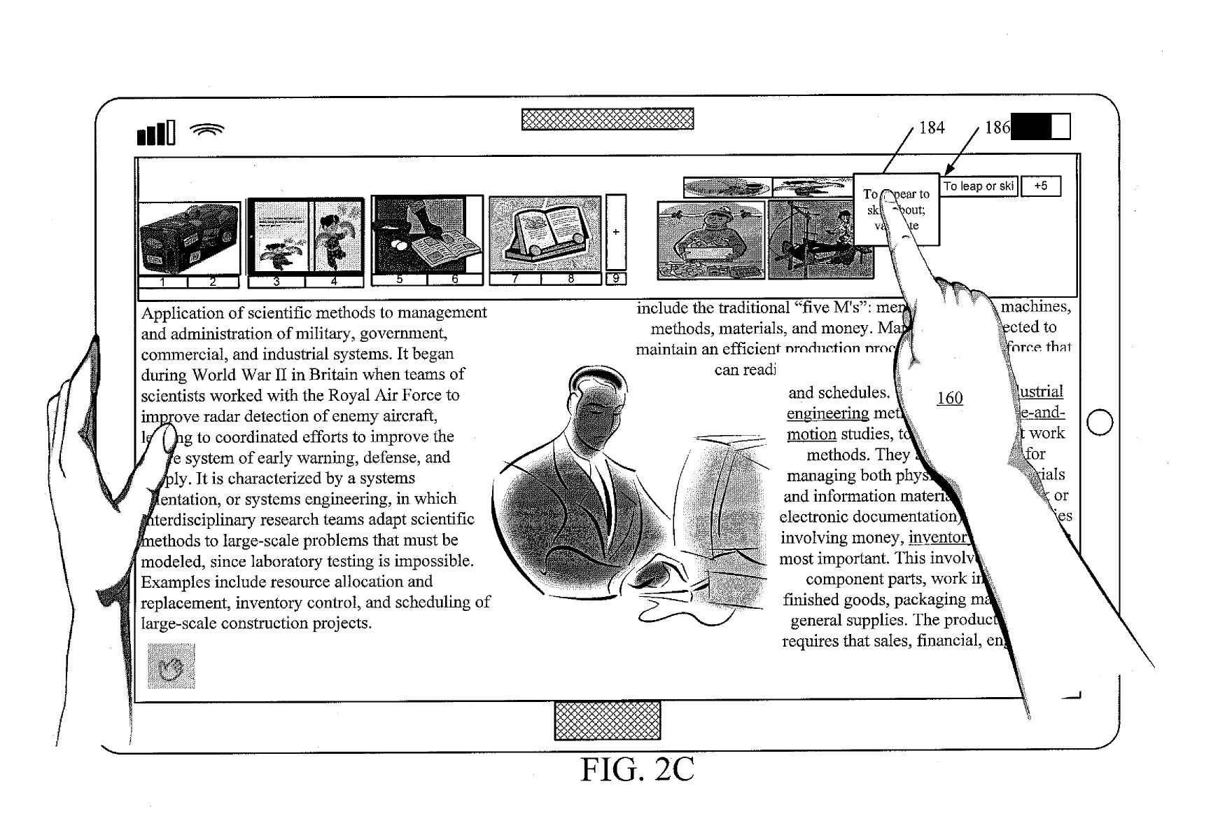

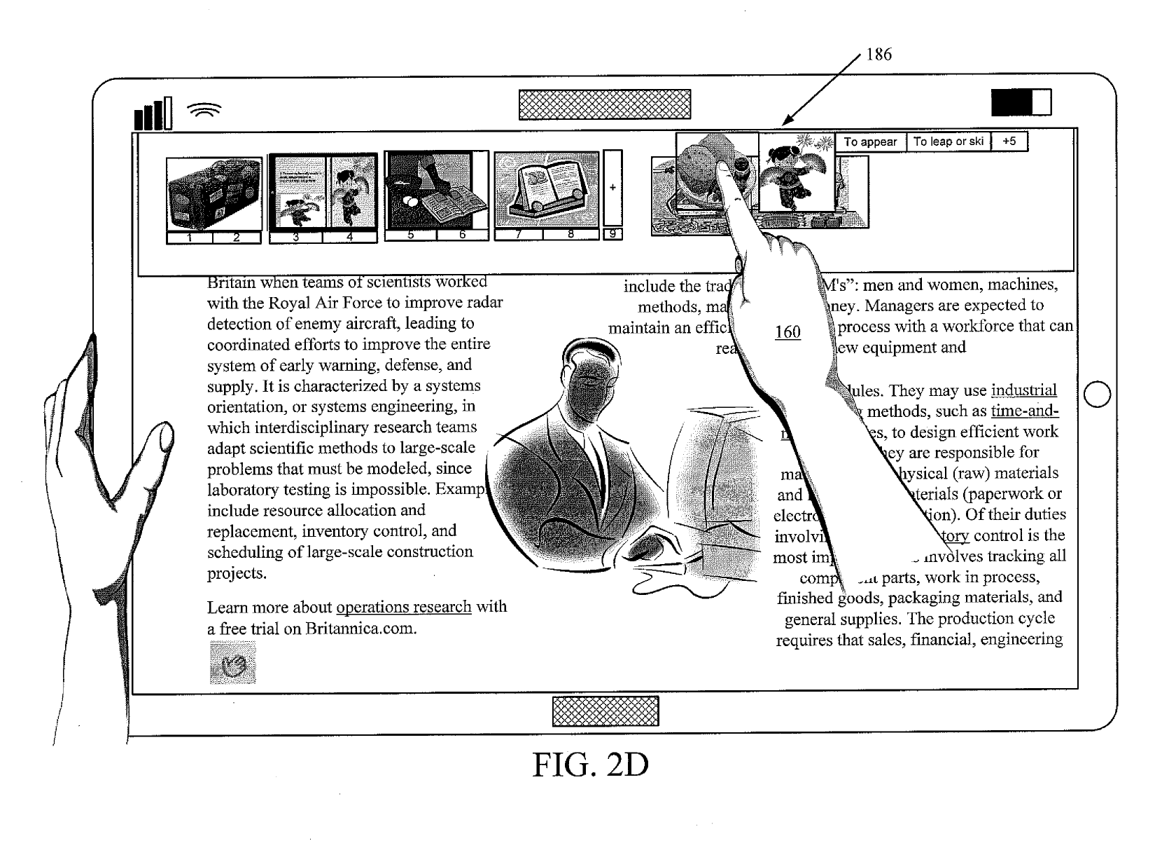

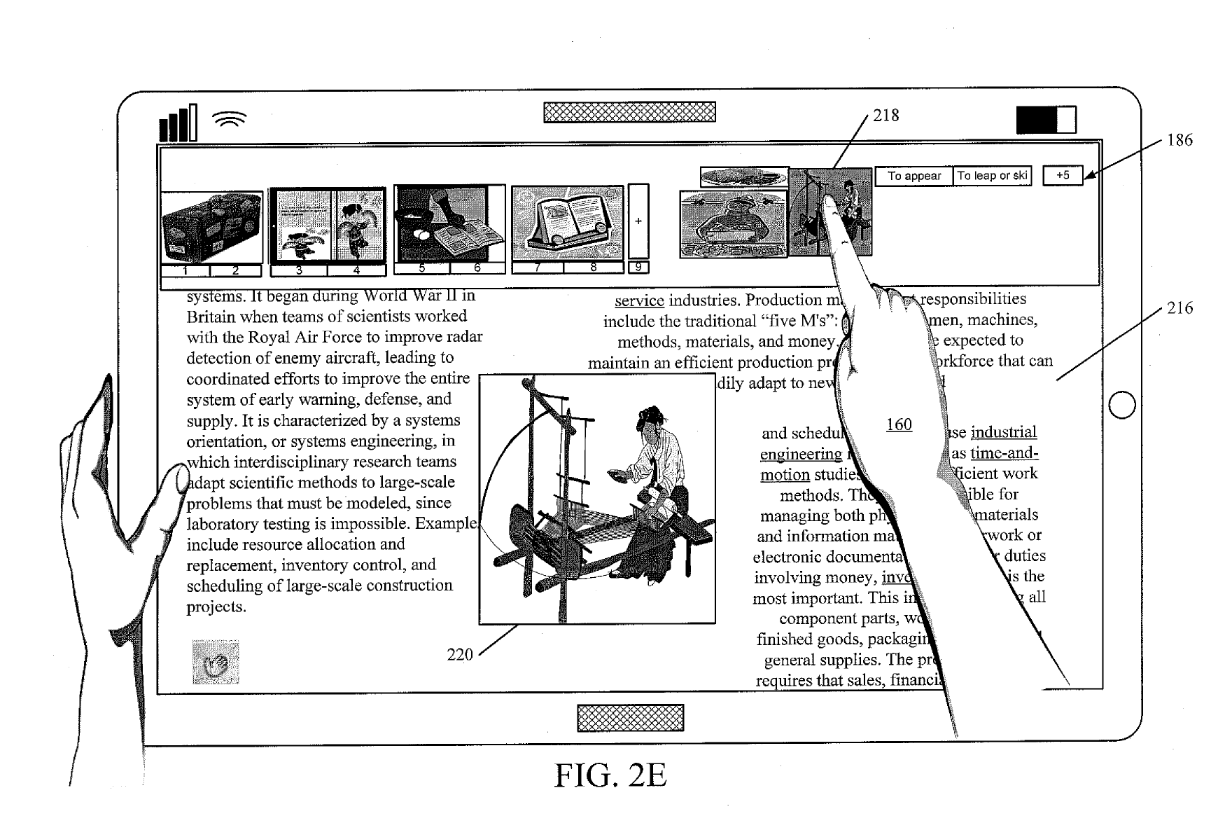

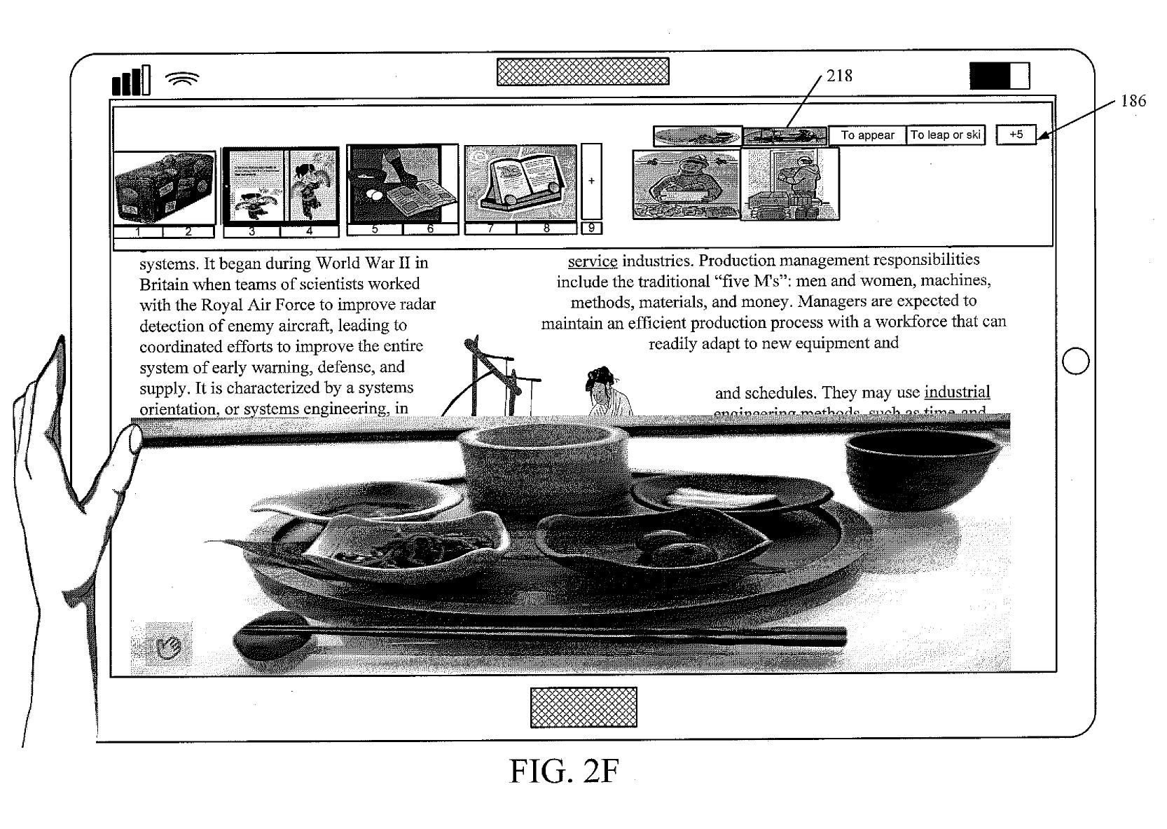

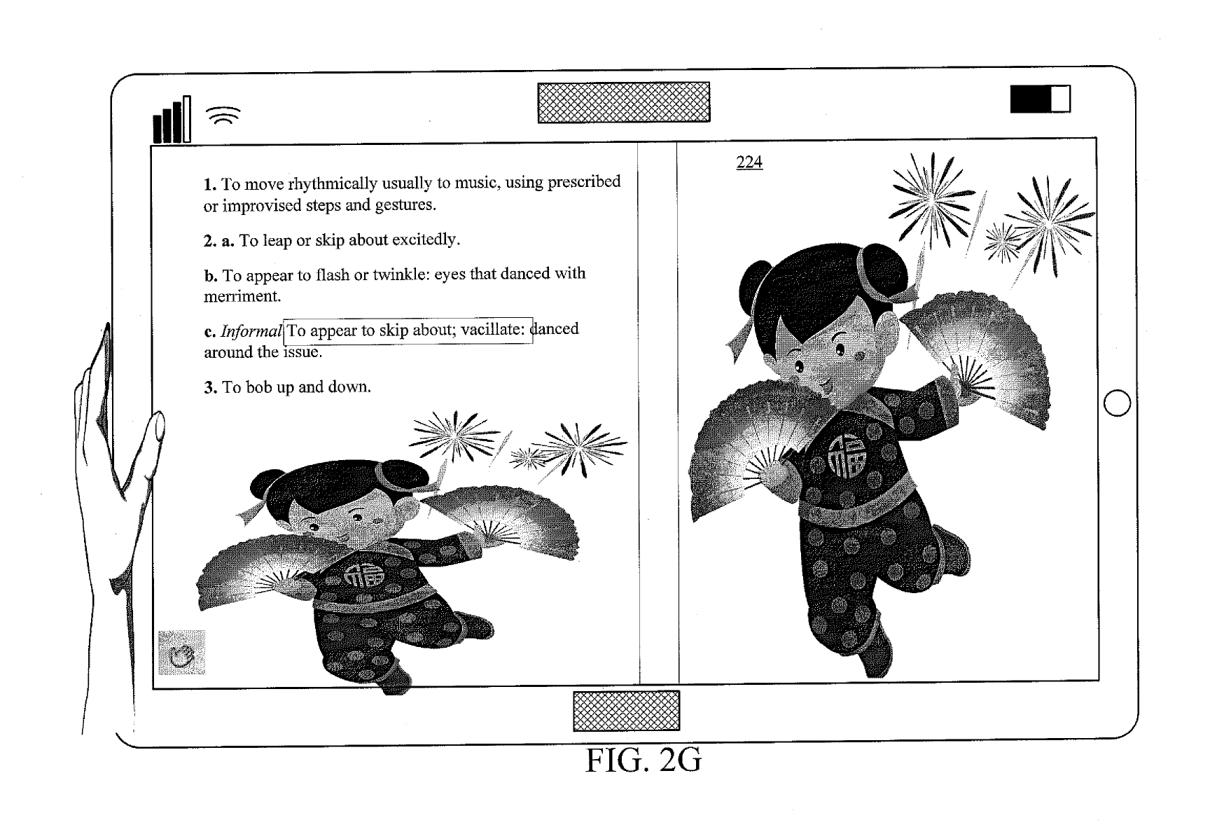

FIG. 2 is a flow diagram illustrating one embodiment of the operation of system 100 shown in FIG. 1 in greater detail. In one embodiment, user 118 has accessed one of applications 106 and the application 106 has generated a user interface display 112 with displayed content. This is indicated by block 150 in FIG. 2.

Next, the application 106 receives, through user input mechanisms 114 on user interface displays 112 a user input identifying an item from the displayed content that is to be clipped and placed on the clip board. This is indicated by block 152 in FIG. 2.

FIG. 2A shows one embodiment of a tablet computer 154 with a user interface display 156 displayed thereon. It can be seen that user interface display 156 includes a number of images, along with text. It can also be seen that the text “to appear to skip; vacillate” has been outlined by a box 158. This indicates that the user has used his or her hand 160, or a stylus, or another suitable user input mechanism, and has highlighted (or selected) that text in box 158. Again, this can be done using a touch gesture as indicated by block 162, using a point and click device, such as a mouse or track ball as indicated by block 164, using key strokes on a keyboard or keypad as indicated by block 166, using voice inputs as indicated by block 168, or in other ways as well, as indicated by block 170.

After the user has provided an input identifying content to be clipped, application 106 receives a user input, through user input mechanisms 114, indicating that user 118 is placing the clipped item on the clip board (e.g., in clipped item data store 122 in clip board system 102). This is indicated by block 172 in FIG. 2. This can also be done in a variety of different ways. For instance, user 118 can provide key strokes indicating that the clipped item is to be placed on the clip board. This is indicated by block 174. The user can also use various buttons or other user input mechanisms 114, and this is indicated by block 176, or the user can use other input mechanisms or provide a user input in other ways, as indicated by block 178.

In one embodiment, the user indicates that the clipped item is to be placed on the clip board using a direct manipulation of the clipped content. This is indicated by block 180 in FIG. 2. In such an embodiment, the direct manipulation can be, for instance, a drag and drop operation in which user 118 visually drags the clipped item to the clip board. FIG. 2B shows one illustrative user interface display 182 that indicates this. It can be seen in FIG. 2B that the user has selected the content in box 158 to be placed on the clip board. The user has then touched the clipped content with his or her finger 160. In one embodiment, this causes a thumbnail 184 to be generated for clipped content in box 158. As the user begins to move his or her finger 160 on the screen, thumbnail 184 is dragged along underneath the user's finger 160. In the embodiment shown in FIG. 2B, the user drags thumbnail 184 in a direction toward a clipboard display 186 on user interface display 182. The clipboard display, in the embodiment shown in FIG. 2B, displays thumbnails of clipped items that are currently placed on the clip board, and this is described in greater detail below. Suffice it to say, for now, that the user begins directly manipulating a thumbnail 184 corresponding to the elected text or content 158 that is to be clipped. When the user beings dragging the thumbnail towards the clip board, clip board operations component 121 generates a visual affordance of the clipped item on the clip board.

In one embodiment, in order to have the selected content in box 158 placed on the clip board, user 118 drags the thumbnail 184 corresponding to the clipped content all the way up to a visual location of the clip board (e.g., a clip board ribbon) shown at 186. However, other drag and drop operations can be performed as well. For instance, clip board operations component 121 can generate the visual affordance of the clipped item on the clip board 186 as soon as the user touches the clipped content in box 158 and as soon as thumbnail 184 is generated. In another embodiment, clip board operations component 121 will not generate the visual affordance of the clipped item on the clip board until user 160 has dragged the thumbnail 184 all the way to the clip board portion of the visual display. In yet another embodiment, when the user drags thumbnail 184 across a boundary or into a given region of the display, that indicates that the user wishes to place the clipped content on the clip board, and the visual affordance is generated at that point.

One way of using the latter example for generating the visual affordance is the following. In one embodiment, application 106 allows the user to scroll or pan around within a given document. Therefore, the content will not be placed on the clipboard unless the user moves the corresponding thumbnail 184 into a desired location or across a boundary on the visual display. By way of one example, it may be that the boundary is set on the far right of the visual display so that when the user drags thumbnail 184 across that boundary (to the far right of the visual display) it is placed on a clip board and the visual affordance is generated. Of course, the boundary could be placed on the bottom of the visual display, on the top of the visual display, or on any other region of the visual display. Similarly, it may be that clip board operations component 121 places the clipped item on the clip board when the user 118 performs a combination of operations. For instance, if the user places his or her thumb 161 on a given icon or portion of the visual display, and when the user combines this with moving thumbnail 184 to a selected position on the visual display, then clipboard operations component 121 places the clipped item on the clip board (by storing it in clipped item data store 122) and generates the corresponding visual affordance. All of these different types of operations for placing a clipped item on the clip board are contemplated herein.

In any case, once the user has provided the user input indicating that the user wishes to place the clipped item on the clip board, clip board operations component 121 stores the clipped item in clipped item data store 122. This is indicated by block 190 in FIG. 2. It will be noted that clip board operations component 121 can place the clipped item itself on the clip board, as indicated by block 192. Clip board operations component 121 can also store, along with the clipped item itself, related data or information as indicated by block 194. For instance, as is described in greater detail below, user 118 may select the clipped item and place it on the clip board using a first device, and then access it later using a second device or using even a different application 106. In that case, clip board operations component 121 might store, in addition to the clipped item itself, related information 194. Such related information may include the time and place the clipped item was placed on the clip board, the originating device that user 118 used to place it on the clip board, the originating application 106 that user 118 was interacting with when the clipped item was placed on the clip board, the type of item (such as object type) of the clipped item, user information identifying the user 118, enterprise related information, such as permissions, authentication information, role-based access information, or other security or permissions used in accessing data, etc. This related information 194 is described for the sake of example only, and other or different related information could be obtained as well.

Once the clipped item is placed on the clip board (e.g., stored in clipped item data store 122 in clip board system 102) clip board visualization component 120 generates a visual affordance of the clipped item on the clip board. This is indicated by block 196 in FIG. 2. Exemplary visual affordances are shown generally at 186 in FIG. 2B. FIG. 2B shows the visual display with two display ribbons 198 and 186. Display ribbon 198 includes a plurality of thumbnails for the various pages of the document being displayed on the main display canvas portion of user interface display 182. By touching one of the page display thumbnails 200, user 118 can skip to that page. Clipboard ribbon 186 includes thumbnails for each of the clipped items that have been placed on the clip board. FIG. 2B shows that ribbon 198 partially hides ribbon 186. However, in one embodiment, the user can touch one of the thumbnails in ribbon 186 to display the complete thumbnail corresponding to the clipped item. In another embodiment, the user can perform a variety of different user inputs that cause ribbon 186 to be displayed over the top of ribbon 198, or instead of ribbon 198. Of course, ribbon 186 can be displayed at different locations on the user interface display and the location shown in FIG. 2B is shown for the sake of example only.

It will also be noted that the visual affordance corresponding to the clipped item need not necessarily be a thumbnail. The thumbnail is indicated by block 202, but the visual affordance could also be a different type of icon 204, a different type of image 206, a simple text string 208, or another visual affordance 210 that corresponds to the clipped item, and gives the user some type of identifying information identifying the content of the clipped item that has been placed on the clip board. All of these are indicated by way of example only.

At any time, user 118 can review items that are placed on the clip board. For instance, if user 118 touches one of the visual affordances in display 186, this can cause the entire thumbnail to be displayed. FIG. 2C shows one embodiment of this. It can be seen in FIG. 2C that the user's hand or finger 160 is now placed on the visual affordance corresponding to thumbnail 184 in ribbon 186. In that case, the clip board visualization component 120 causes the entire thumbnail 184 to be displayed so that the user can view the entire thumbnail 184 corresponding to that clipped item. In another embodiment, the user can preview multiple thumbnails corresponding to the clipped items by using touch gestures, or other gestures. For instance, in one embodiment, if the user touches ribbon 186 and swipes to the left or to the right (or up or down as desired), this will cause multiple thumbnails corresponding to multiple clipped items to be displayed. FIG. 2D shows one embodiment of this. It can be seen in FIG. 2D that the user has input a touch gesture on ribbon 186 which has caused two of the thumbnails from ribbon 186 to be fully displayed to the user. In another embodiment, the user can provide a user input (such as a suitable touch gesture) to cause the entire ribbon 186 to be displayed over the top other items on the visual display so that all of the thumbnails corresponding to all clipped items are fully displayed for user review.

Similarly, in one embodiment, the user can select different thumbnails to be fully displayed by simply sliding his or her finger along the visual affordances in ribbon 186. As the user's finger moves from one visual affordance to the next, the complete thumbnail being displayed for user review will change.

User 118 can then provide a user input to clip board operations component 121 to retrieve a clipped item from clipped item data store 122. This is indicated by block 212 in FIG. 2. This can also be done in a number of different ways. For instance, the user can use a direct manipulation to retrieve an item from the clip board. In that embodiment, the user can touch one of the visual affordances so that the entire thumbnail is revealed to the user. The user can then drag that thumbnail to a given position on the user interface display and execute another touch gesture to place the clipped item at that location. For instance, the user can drag the icon to the desired location and then tap the icon or simply remove his or her finger from the touch sensitive display in order to drop the clipped item at that location. Of course, the user can use other user inputs as well. For instance, the user can select a location by tapping the screen and then retrieve an item from the clip board by simply tapping the visual affordance corresponding to that clipped item. In that case, clip board operations component 121 can place the clipped item that was tapped at the previously selected location, without the user needing to drag and drop the thumbnail corresponding to that location. The user can use keystrokes to remove a clipped item from the clip board and place it at a given location, or the user can use a wide variety of other use inputs to retrieve an item from the clip board and place it at a given location. Similarly, the user can preview the clipped item first as well. This is indicated by block 214 in FIG. 2. FIG. 2E shows one embodiment of this.

FIG. 2E shows one illustrative user interface display 216 illustrating one or more of the embodiments discussed above. It can be seen that the user has used his or her finger 160 to select one of the visual affordances in clip board ribbon 186. This causes the entire thumbnail 218 corresponding to that clipped item to be displayed. It can also be seen that the user has previously selected a location 220 on the visual display so that when the user selects the thumbnail 218 (such as by tapping it, dragging and dropping it) the clipped item is retrieved from the clip board (e.g, clip board operations component 121 retrieves it from clipped item data store 122) and it is placed at the selected location 220 (e.g., clip board operations component 121 pastes it to the selected location 220) on the visual display. Retrieving clipped items from the clipped item data store 122 can be done in a wide variety of other ways as well. Placing the clipped item at a given location within the content on the visual display is indicated by block 220 in FIG. 2.

FIG. 2F shows that, in one embodiment, the user can navigate to different pages or have different displays pulled up and shown on the visual display, even while the clip board ribbon 186 is still displayed on the visual display. For instance, the user can page between various pages or open different applications on the same device, and clip board ribbon 186 and clip board system 102 will still display clip board ribbon 186 indicating the various clipped items that are currently on the clip board.

FIG. 2G shows another user interface display 224 in which the clip board ribbon 186 is hidden. For instance, by providing a given user input to clip board system 102, clip board visualization component 120 can hide the clip board until the user provides another user input indicating that the user wishes to view the clip board ribbon 186.

It will be noted, of course, that while the above discussion has been provided with respect to touch gestures, user inputs could take other forms as well. The visual affordance provided on the visual display, that indicates the clipped items that are currently on the clip board, provides the user with intuitive feedback as to what is on the clip board, so that the user need not remember that. Similarly, where the user input mechanisms allow the user 118 to provide direct manipulation of clipped items, on the visual display, this also provides an intuitive interface that allows the user to quickly and easily manipulate clipped items. Similarly, it will be noted that the clip board system 102 can provide the visual affordances across various applications 106. Therefore, even as user 118 navigates among different applications 106, the clipped items can easily be moved from one application to the next. Further, as described in greater detail below, clip board system 102 can provide user 118 with access to the clipped items even across different devices. This further enhances the user's ability to use clipped items on clip board system 102.

FIG. 3 is a block diagram illustrating one embodiment in which clip board system 102 is deployed with respect to a plurality of different client devices, so that the clipped content can be used across those multiple devices. FIG. 3 shows that clip board system 102 is disposed on a clip board service component 300. Clipped item data store 122 is shown separate from clip board system 102. Component 300 is shown with a processor 302. As with processor 104, processor 302 is illustratively a computer processor with associated memory and timing circuitry (not separately shown). It is a functional part of component 300, is activated by and facilitates the functionality of the other systems and items in component 300.

FIG. 3 also shows that clip board service component 300 is accessed by a user that uses client device 304. Client device 304 can illustratively access clip board service component 300 directly, or through another system 306. FIG. 3 also shows that additional client devices 308 and 310 are disposed to access component 300 as well. Client devices 308 and 310 can illustratively access component 300 directly (in one embodiment) or through other systems 306, or both.

In one embodiment, other systems 306 include a network, such as a wide area network or a local area network. Client devices 304, 308 and 310 can access clip board service component 300 through the network. Clip board service component 300 thus provides clip board services (such as the functionality to perform clipboard operations to cut, copy and paste items to a clip board by storing them in clipped item data store 122) and to retrieve items from the clip board (e.g., from clipped item data store 122). In such an embodiment, processor 302 of clip board services component 300 is a server that provides clip board services to the various client devices 304, 308 and 310, through the network that comprises other systems 306.

In another embodiment, as is described in greater detail below, clip board service component 300 is provided as a cloud-based service. In still another embodiment, clipped item data store 122 is provided as cloud-based storage. Cloud-based systems are described in greater detail below. FIG. 3 also shows that client device 304 can be a variety of different devices, such as cell phone 312, smart phone 314, tablet computer 316, any of a wide variety of other mobile devices 318, desktop computer 320, laptop computer 322, game console 324, personal digital assistant 326, multimedia player 328, entertainment system 330, television 332, camera 334 server 336 or any of a wide variety of other devices 338.

FIG. 4 is a flow diagram illustrating one embodiment of the operation of the system shown in FIG. 3. It will be noted, in one embodiment, a user using any of devices 312-338 can place items on the clip board by accessing clip board system 102 which stores the items in clipped item data store 122. The user can then use any of the other devices 312-338 in order to access the clipped items on clipped item data store 122. In doing so, client device 304 illustratively generates a user interface display to a first device of devices 312-338 so that the user can perform clip board operations using clip board system 102. The client device then receives a user input from a first device (of devices 312-338) placing one or more clipped items on the network-based clip board. These user inputs are provided to clip board system 102 which provides the functionality for storing the clipped items in clip item data store 122. Receiving the user inputs is indicated by block 350 in FIG. 4. Again, it will be appreciated that clip board service component 300 can be a cloud-based service 352, or the clipped item data store 122 can be provided in a cloud-based storage system 354. Of course, the architecture of the system can be set up in other ways as well, as indicated by block 356.

Once the user identifies the clipped item to be stored on the clip board, clip board system 102 stores the clipped item in clipped item data store 122. This is indicated by block 358 in FIG. 4.

Clip board system 102 illustratively causes client device 304 to provide related information 128-130, that is related to the clipped items placed in clip item data store 122. This is indicated by block 360 in FIG. 4. This can take a wide variety of different forms. For instance, the related information can include the type of clipped item 362, the time that the clipped item was placed on the clip board as indicated by block 364, the place 366 where the item was placed on the clip board (such as at the user's office, the user's home, etc.), the originating device 312-338 that was used to place the item on the clip board as indicated by block 368, the originating application that was being used by the user when the clipped item was placed on the clip board, as indicated by block 370, user information that identifies the user, as indicated by block 372, enterprise information, such as permissions or other user authentication or identification information that can be used to implement security, as indicated by block 274, or a wide variety of other information, as indicated by block 376.

In the embodiment being described with respect to FIG. 4, the user places the clipped item on the clip board (by having it stored in clipped item data store 122) using a first device and then wishes to retrieve the clipped item using a second device, which is different from the first device. In that case, the second device (which comprises another of devices 312-338) illustratively generates a user interface display that has user input mechanisms for receiving user inputs to perform clip board operations. The second device receives a user input retrieving a clipped item from clipped item data store 122. This is indicated by block 378 in FIG. 4. The application being used by the user to retrieve a clipped item, or another security system or security component, can then implement security based upon the related information stored for the clipped item that is currently being retrieved. Implementing security is indicated by block 380 in FIG. 4. It will be noted that the security can take a wide variety of different forms. For instance, the security can be role-based security, it can be user-based security, or it can be a wide variety of other, different types of security.

It should also be noted, that, in one embodiment, clip board system 102 can optionally modify the clipped item based upon the type of the second device. For instance, if the clipped item was placed on the clip board using a desk top computer 320, but the user is now retrieving the clipped item using a smart phone 314, clip board system 102 can perform additional processing to reformat or resize the clipped item, based upon the various different devices that were used to place the clipped item on the clip board and to retrieve it from the clip board. This is indicated by block 382 in FIG. 4.

Finally, clip board system 102 moves the clipped item to the second device that is being used by the user in order to retrieve the clipped item. This is indicated by block 384. It can thus be seen from FIGS. 3 and 4 that the clip board system can be provided using a clip board service component 300 that can be a network-based service, such as a cloud-based service, or another type of service. In any case, the user can use a variety of different types of devices to access the same clipped items on the clip board. That is, the clip board operations and functionality are provided independently of the various devices, and across a wide variety of different kinds of devices. This enhances the user's ability to access clipped content, and to move content across various applications and devices.

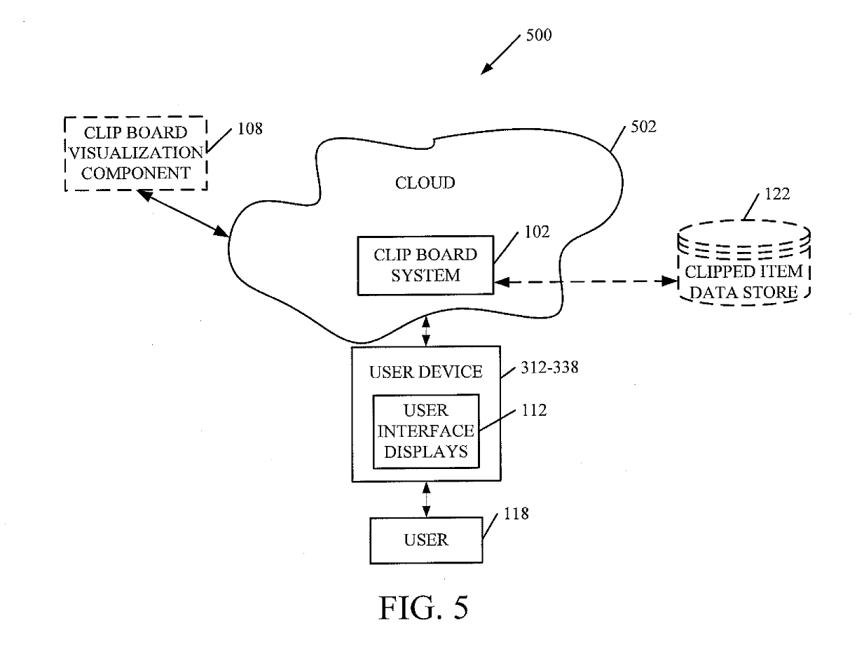

FIG. 5 is a block diagram of system 100, shown in FIGS. 1 and 3, except that it is specifically disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 5, some items are similar to those shown in FIGS. 1 and 3 and they are similarly numbered. FIG. 5 specifically shows that clip board system 100 is located in cloud 502 (which can be public, private, or a combination where portions are public while others are private). Therefore, user 118 uses a user device 312-338 to access those systems through cloud 502.

FIG. 5 also depicts another embodiment of a cloud architecture. FIG. 5 shows that it is also contemplated that some elements of system 100 are disposed in cloud 502 while others are not. By way of example, data store 132 can be disposed outside of cloud 502, and accessed through cloud 502. In another embodiment, clip board visualization component 120 is also outside of cloud 502. Regardless of where they are located, they can be accessed directly by device 312-338, through a network (either a wide area network or a local area network), they can be hosted at a remote site by a service, or they can be provided as a service through a cloud or accessed by a connection service that resides in the cloud. All of these architectures are contemplated herein.

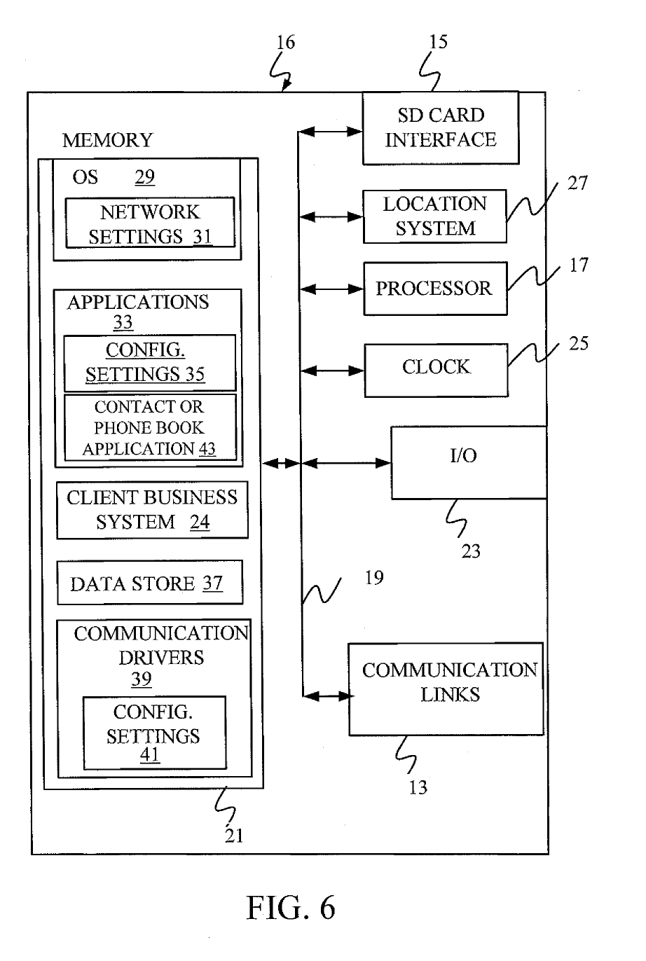

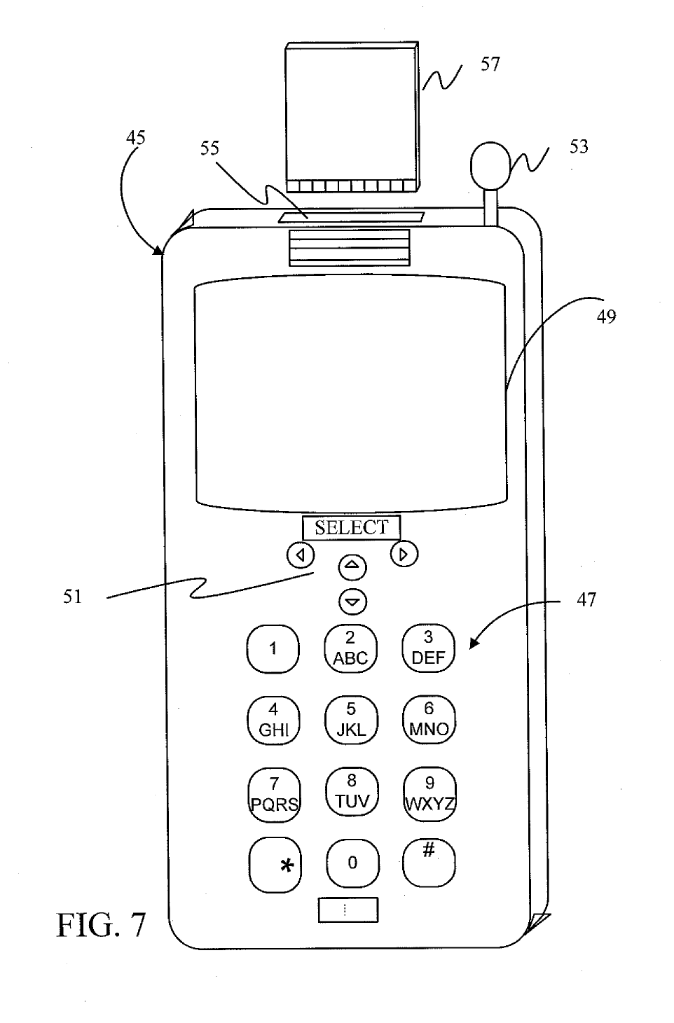

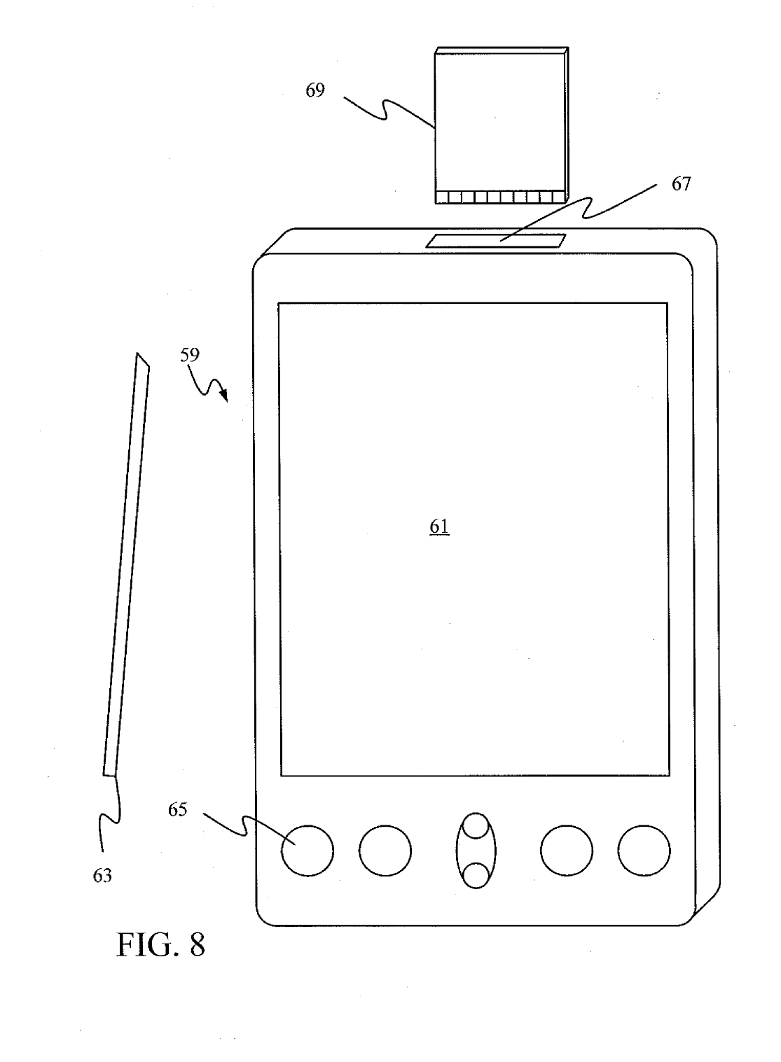

FIG. 6 is a simplified block diagram of one illustrative embodiment of a handheld or mobile computing device that can be used as a user's or client's hand held device 16, in which the present system (or parts of it) can be deployed. FIGS. 7-8 are examples of handheld or mobile devices.

FIG. 6 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like system 100) are received on a removable Secure Digital (SD) card that is connected to a SD card interface 15. SD card interface 15 and communication links 13 communicate with a processor 17 (which can also embody processors 104 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. System 100 or the items in data store 108 or 122, for example, can reside in memory 21. Similarly, device 16 can have a client business system 24 which can run various business applications or embody parts or all of system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

As discussed above with respect to FIGS. 2A-2F, device 16 can also be a tablet computer with a touch sensitive display screen, so touch gestures from a user's finger can be used to interact with the application. The tablet computer can also provide a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. The tablet computer can also illustratively receive voice inputs as well.

FIGS. 7 and 8 provide additional examples of devices 16 that can be used, although others can be used as well. In FIG. 7, a smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 8 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the devices 16 are possible.

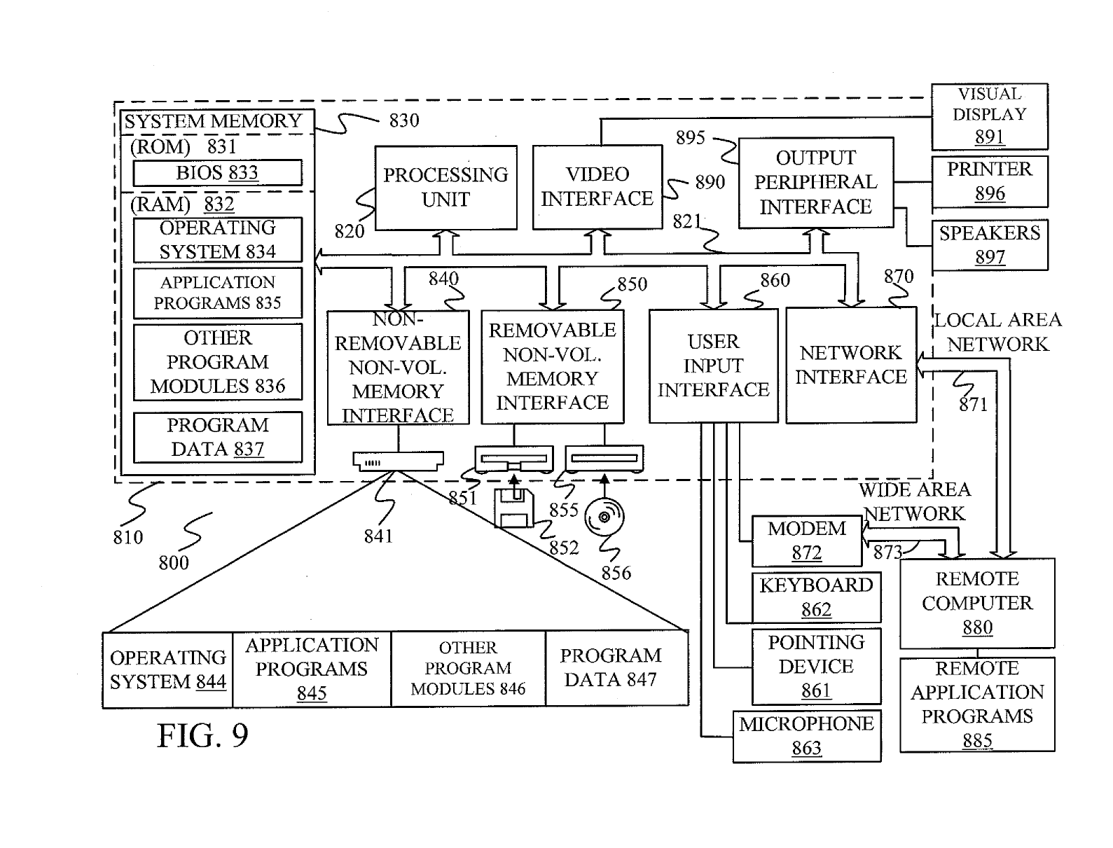

FIG. 9 is one embodiment of a computing environment in which system 100 (for example) can be deployed. With reference to FIG. 9, an exemplary system for implementing some embodiments includes a general-purpose computing device in the form of a computer 810. Components of computer 810 may include, but are not limited to, a processing unit 820 (which can comprise processor 104), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

The embodiments shown in the Figures above can be combined with one another as well. For instance, features of one embodiment can be combined with features of one or more other embodiments. This is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A clip board system, comprising:
a clip board visualization component generating a visual affordance corresponding to each clipped item stored on a clip board, each given visual affordance displaying information indicative of the corresponding given clipped item;
a clip board operations component receiving a clip board operations user input to perform a clip board operation on a selected clipped item; and
a computer processor, being a functional part of the clip board system and activated by the clip board visualization component and the clip board operations component to facilitate generating the visual affordance and performing the clip board operation.

2. The clip board system of claim 1 wherein the clip board operations component receives, as the clip board operations user input, a direct manipulation user input, directly manipulating the visual affordance corresponding to the selected clipped item.

3. The clip board system of claim 2 wherein the clip board operations component receives a drag and drop user input on the visual affordance corresponding to the selected clipped item and performs the clip board operation based on the drag and drop user input.

4. The clip board system of claim 2 wherein the clip board operations component performs a cut or copy operation on the clipped item and places the clipped item on the clip board based on the drag and drop user input.

5. The clip board system of claim 2 wherein the clip board operations component retrieves the clipped item and pastes the clipped item on a content canvas at a location based on the drag and drop user input.

6. The clip board system of claim 5 wherein the clip board operations component performs the cut or copy operation to obtain the clipped item from a first application and place it on the clip board and pastes the clipped item on a content canvas of a second application, different from the first application.

7. The clip board system of claim 5 wherein the clip board operations component receives the drag and drop user input to perform the cut or copy operation to obtain the clipped item on a first device and generates the visual affordance for the clipped item and receives a second drag and drop user input to paste the clipped item on a content canvas displayed on a second device, different from the first device.

8. The clip board system of claim 1 wherein the clip board visualization component generates a visual affordance for each clipped item on the clip board and displays the visual affordances for direct manipulation by the user to perform clip board operations on the clipped items.

9. The clip board system of claim 1 and further comprising:
a clipped item data store storing clipped items that are on the clip board.

10. The clip board system of claim 1 further comprising:
a server component that provides access to the clipboard operations component and the clip board visualization component as a service.

11. The clip board system of claim 10 wherein the service comprises a cloud-based service.

12. A computer-implemented method, comprising:
receiving, through a user interface display, a clip board user input selecting content to be saved to a clip board;
saving the selected content to the clip board; and
displaying a visual affordance on a user interface display, the visual affordance corresponding to the selected content saved to the clip board.

13. The computer implemented method of claim 12 and further comprising:
receiving a retrieve user input retrieving the selected content from the clip board and pasting it to a given location in content displayed on the user interface display.

14. The computer-implemented method of claim 12 wherein receiving a clip board user input comprises:
receiving a direct visual manipulation of the selected content through the user interface display.

15. The computer-implemented method of claim 14 wherein receiving the direct visual manipulation comprises:
receiving a drag and drop input dragging a representation of the selected content on the user interface display to place the selected content on the clip board.

16. The computer-implemented method of claim 13 wherein the clip board user input is received through a first application and wherein the retrieve user input is received through a second application.

17. The computer-implemented method of claim 13 wherein the clip board user input is received through a first user device and wherein the retrieve user input is received through a second device.

18. The computer-implemented method of claim 13 wherein receiving and saving are performed on a cloud-based service.

19. A computer readable storage medium storing computer readable instructions which, when executed by a computer, cause the computer to perform a method, comprising:
receiving, through a user interface display, a clip board user input selecting content to be saved to a clip board, the clip board user input comprising a drag and drop input dragging a representation of the selected content on the user interface display to place the selected content on the clip board;
saving the selected content to the clip board;
displaying a visual affordance on a user interface display, the visual affordance corresponding to the selected content saved to the clip board; and
receiving a retrieve user input retrieving the selected content from the clip board and pasting it to a given location in content displayed on the user interface display.

20. The computer readable medium of claim 19 wherein receiving and saving are performed on a cloud-based service so the selected content saved on the clip board is accessible through a plurality of different user devices and a plurality of different applications.
